(19) United States
(12) Patent Application Publication
(10) Pub. No.: US 2023/0130847 A1
(43) Pub. Date: Apr. 27, 2023

(54) ALIGNING DU/MT TRANSMISSION TIMING

(71) Applicant: Telefonaktiebolaget LM Ericsson (publ), Stockholm (SE)

(72) Inventors: Erik DAHLMAN, Stockholm (SE); Magnus ÅSTRÖM, Lund (SE); Boris DORTSCHY, Vendelsö (SE); Lei BAO, Göteborg (SE); Behrooz MAKKI, Pixbo (SE)

(21) Appl. No.: 17/915,226

(22) PCT Filed: Apr. 8, 2021
(86) PCT No.: PCT/SE2021/050318

§ 371 Date: Sep. 28, 2022

Related U.S. Application Data
(60) Provisional application No. 63/006,985, filed on Apr. 8, 2020.

(51) Int. Cl. H04W 56/00

(52) U.S. Cl. CPC H04W 56/0045; H04W 56/0015

(57) ABSTRACT

A method, system and apparatus are disclosed for aligning Distributed Unit/Mobile Termination (DU/MT) transmission timing. In one embodiment, a method in a network node includes adjusting a first transmission timing to align with a second transmission timing, the first transmission timing comprising one of a Distributed Unit, DU, and a Mobile Terminated Unit, MT, transmission timing at the network node and the second transmission timing comprising another one of the DU and the MT transmission timing at the network node. In another embodiment, a method in a network node includes receiving an MT transmission based at least in part on an adjustment of a first transmission timing to align with a second transmission timing.

### FIELD

The present disclosure relates to wireless communications, and in particular, to aligning Distributed Unit/Mobile Termination (DU/MT) transmission timing.

### BACKGROUND

In the Third Generation Partnership Project (3GPP) Release 16 (Rel-16), there is an ongoing Work Item (WI) for Integrated Access Backhaul (IAB) based on an earlier study item documented in 3GPP Technical Report (TR) 38.874. One purpose of IAB is to replace existing wired backhaul or a wireless backhaul with flexible wireless backhaul using the existing 3GPP bands, providing not only backhaul but also existing cellular services in the same node.

Each IAB node holds a Distributed Unit (DU) function and a Mobile Termination (MT) function as shown in a reference architecture, an example of which is depicted in FIG. 1. Via the MT, the IAB node connects to an upstream IAB node, which could also be an IAB donor node. Via the DU, the IAB node establishes radio link control (RLC) channels to MTs of downstream IAB nodes or provides access links to wireless devices (WDs). FIG. 1 conceptually shows an example of the possible connections for an IAB node, including access link to WDs and backhaul links to both an upstream parent and a downstream child IAB node.

An IAB node may carry out at least two types of transmissions:
MT transmissions towards a parent IAN node, and
DU transmissions towards devices and child IAB nodes.

The timing of MT transmissions is controlled by the parent node in the same way as the timing of WD transmissions is controlled by the serving cell:
When initially accessing a parent node by a random-access procedure, the MT is provided with an initial timing-correction command as part of the random-access response.
After the connection to the parent node has been established, the MT transmission timing can be further adjusted based on subsequent timing-advance (TA) commands provided by the parent node by means of medium access control (MAC) control element (CE) signalling.

The parent-node control of the MT transmission timing typically aims at aligning the parent-node reception timing of different WD and MT transmissions received by the parent node. By aligning the reception timing of different WD and MT transmissions, the receiver-side orthogonality between frequency-multiplexed transmissions, is retained. Furthermore, a single discrete Fourier transform (DFT) can be used at the parent node for the demodulation of the different transmissions. The reception timings of the different WD and MT transmissions may not be perfectly aligned but should preferably be aligned at least within the span of the cyclic prefix (CP).

Regarding the timing of DU transmissions, there is a statement in the 3GPP specifications that, for operation in unpaired spectrum, the downlink transmission timing of all cells with overlapping coverage should be mutually aligned within a window of 3 μs (see for example 3GPP Technical Specification (TS) 38.133). This also applies for cells created by an IAB node DU, at least in cases of operation in unpaired spectrum.

Such alignment of the downlink transmission timing between nodes can be achieved in several ways, including, for example, the use of global positioning system (GPS) reception at the IAB node together with an agreed absolute transmission timing. However, IAB also supports over-the-air (OTA) based transmission-timing alignment where an IAB node can derive its DU transmission timing solely from signals received from the parent node.

The basic principle of OTA-based transmission-timing alignment is that the IAB node should set its DU transmission timing an amount Tₚᵣₒₚ ahead of the timing of signals received from the parent node, where Tₚᵣₒₚ is the propagation time from the parent node to the IAB node. In this way, the DU transmission timing of the IAB node is aligned with the DU transmission timing of its parent node, in line with the general requirement of aligned downlink transmission timing between cells. The task of OTA-based transmission-timing alignment may thus be equivalent to accurately estimating the propagation time between the IAB node and its parent node.

FIG. 2 illustrates an example of the timing relation (transmit and receive timing) between the DU and MT on each side of an IAB backhaul link (DU at the parent node and MT at the child node), according to current specifications. Given an offset T_{A} between the downlink reception timing and uplink transmission timing at the MT and an offset T_{Δ} between the uplink reception timing and downlink transmission timing at the parent-node DU, it can be seen that the propagation time can be estimated as \hat{T}ₚᵣₒₚ=(T_{A}−T_{Δ})/2.

Offset T_{A} is inherently known at the child node while offset T_{Δ} is known at the parent node. To enable the child node to estimate the parent-to-child propagation time, and thus to enable OTA-based timing alignment, the 3GPP specifications support that the parent node provides T_{Δ} to the child node by means of medium access control (MAC) control element (CE) signaling.

### SUMMARY

Some embodiments advantageously provide methods, systems, and apparatuses for aligning Distributed Unit/Mobile Termination (DU/MT) transmission timing.

In one embodiment, a method implemented in a network node configured to communicate with at least one parent node over a backhaul network includes optionally, receiving a command related to timing alignment from a parent node; and adjusting a Distributed Unit (DU) transmission timing to align with at least one Mobile Terminated Unit (MT) transmission timing based at least in part on the command.

In another embodiment, a method implemented in a network node configured to communicate with at least one child node over a backhaul network includes sending a command related to timing alignment to a child node; and receiving a transmission based at least in part on a timing, the timing being adjusted to align the child node's Distributed Unit (DU) transmission timing with at least one Mobile Terminated Unit (MT) transmission timing based at least in part on the command.

According to an aspect of the present disclosure, a method implemented in a network node configured to communicate with a parent network node over a backhaul network is provided. The network node comprises a Mobile Terminated Unit, MT, and a Distributed Unit, DU, and the method comprises adjusting a first transmission timing to align with a second transmission timing, the first transmission timing comprising one of a DU and an MT transmission timing at the network node and the second transmission timing comprising another one of the DU and the MT transmission timing at the network node; and transmitting a signaling according to the adjustment of the first transmission timing.

In some embodiments of this aspect, the method further includes performing, by the MT comprised in the network node, an MT transmission to the parent network node; and transmitting the signaling comprises transmitting, by the DU comprised in the network node, a DU transmission to one of a child network node and a wireless device (WD), the MT and DU transmissions at the network node being timing aligned according to the adjustment of the first transmission timing. In some embodiments of this aspect, the first and second transmissions are one of frequency-division multiplexed and spatial-division multiplexed. In some embodiments of this aspect, the adjustment of the first transmission timing comprises an adjustment of the DU transmission timing to align with the MT transmission timing.

In some embodiments of this aspect, the adjustment of the DU transmission timing to align with the MT transmission timing is based at least in part on a timing window. In some embodiments of this aspect, the method further comprises receiving a command comprising the timing window from one of the parent network node, a centralized unit, CU, and an operations, administration, and maintenance, OAM, function. In some embodiments of this aspect, the timing window indicates an amount of deviation allowed for the DU transmission timing relative to an ideal timing alignment of the DU transmission timing to the MT transmission timing. In some embodiments of this aspect, the timing window is one of symmetric and asymmetric about the ideal timing alignment. In some embodiments of this aspect, the timing window is based at least in part on an output power associated with the DU.

In some embodiments of this aspect, the method further includes transmitting an indication of the output power associated with the DU to the parent network node and receiving a command comprising the timing window based on the transmitted indication of the output power. In some embodiments of this aspect, the method further includes receiving a broadcast comprising a plurality of timing windows associated with a plurality of output power values. In some embodiments of this aspect, the method further includes receiving a command comprising a reference window for a reference output power and deriving the timing window from the reference window, the reference output power and an actual output power associated with the DU.

In some embodiments of this aspect, the adjustment of the first transmission timing comprises an adjustment of an MT transmission timing to align with a DU transmission timing is based at least in part on two different types of MT transmission timings, a first type of MT transmission timing following a timing control command from the parent network node and a second type of MT transmission timing aligning to the DU transmission timing at the network node. In some embodiments of this aspect, the first type of MT transmission timing following the timing control command is not aligned to the DU transmission timing at the network node. In some embodiments of this aspect, the first type of MT transmission timing is based at least in part on a relation between the first and second types of MT transmission timings.

In some embodiments of this aspect, the relation is one of derived by and signaled to the parent network node. In some embodiments of this aspect, the adjustment of the MT transmission timing to align with the DU transmission timing is based at least in part on a timing window. In some embodiments of this aspect, the method further includes receiving a command comprising the timing window from one of the parent network nodes, a centralized unit, CU, and an operations, administration, and maintenance, OAM, function. In some embodiments of this aspect, the timing window indicates an amount of deviation allowed for the second type of MT transmission timing relative to the first type of MT transmission timing. In some embodiments of this aspect, the timing window is one of symmetric and asymmetric about the first type of MT transmission timing.

In some embodiments of this aspect, the adjustment of the first transmission timing comprises an adjustment of an MT transmission timing to align with a DU transmission timing following a timing control command from the parent network node. In some embodiments of this aspect, the adjustment of the MT transmission timing following the timing control command is aligned to the DU transmission timing at the network node. In some embodiments of this aspect, the method further includes signaling information about one of a requested adjustment of the MT transmission timing and an estimated propagation time to the parent network node, the timing control command being based at least in part on the signaled information. In some embodiments of this aspect, the method further includes determining a timing offset between the MT and DU transmission timings based at least in part on a timing misalignment of at least one other network node.

In some embodiments of this aspect, a method implemented in a network node configured to communicate with a child network node over a backhaul network is provided. The method comprises transmitting a signaling related to a timing alignment; and receiving a Mobile Terminated Unit, MT, transmission based at least in part on an adjustment of a first transmission timing to align with a second transmission timing, the first transmission timing comprising one of a Distributed Unit, DU, and an MT transmission timing at the child network node and the second transmission timing comprising another one of the DU and the MT transmission timing at the child network node.

In some embodiments of this aspect, the MT transmission received from the child network node is one of frequency-division multiplexed and spatial-division multiplexed with a DU transmission at the child network node. In some embodiments of this aspect, the adjustment of the first transmission timing comprises an adjustment of the DU transmission timing to align with the MT transmission timing. In some embodiments of this aspect, the adjustment of the DU transmission timing to align with the MT transmission timing is based at least in part on a timing window. In some embodiments of this aspect, transmitting the signaling comprises transmitting a command comprising the timing window. In some embodiments of this aspect, the timing window indicates an amount of deviation allowed for the DU transmission timing relative to an ideal timing alignment of the DU transmission timing to the MT transmission timing.

In some embodiments of this aspect, the timing window is one of symmetric and asymmetric about the ideal timing alignment. In some embodiments of this aspect, the timing window is based at least in part on an output power associated with the DU comprised in the child network node. In some embodiments of this aspect, the method further includes receiving an indication of the output power associated with the DU comprised in the child network node; and wherein transmitting the signaling comprises transmitting a command comprising the timing window based on the received indication of the output power. In some embodiments of this aspect, transmitting the signaling comprises transmitting a broadcast comprising a plurality of timing windows associated with a plurality of output power values. In some embodiments of this aspect, transmitting the signaling comprises transmitting a command comprising a reference window for a reference output power, the timing window being derived at the child network node from the reference window, the reference output power and an actual output power associated with the DU comprised in the child network node.

In some embodiments of this aspect, the adjustment of the first transmission timing comprises an adjustment of an MT transmission timing to align with a DU transmission timing based at least in part on two different types of MT transmission timings, a first type of MT transmission timing following a timing control command from the network node and a second type of MT transmission timing aligning to the DU transmission timing at the child network node. In some embodiments of this aspect, the first type of MT transmission timing following the timing control command is not aligned to the DU transmission timing at the child network node. In some embodiments of this aspect, the first type of MT transmission timing is based at least in part on a relation between the first and second types of MT transmission timings.

In some embodiments of this aspect, the relation is one of derived by the network node and received from the child network node. In some embodiments of this aspect, the adjustment of the MT transmission timing to align with the DU transmission timing is based at least in part on a timing window. In some embodiments of this aspect, transmitting the signaling comprises transmitting a command comprising the timing window. In some embodiments of this aspect, the timing window indicates an amount of deviation allowed for the second type of MT transmission timing relative to the first type of MT transmission timing. In some embodiments of this aspect, the timing window is one of symmetric and asymmetric about the first type of MT transmission timing. In some embodiments of this aspect, transmitting the signaling comprises transmitting a timing control command to the child network node, the adjustment of the first transmission timing comprises an adjustment of an MT transmission timing to align with a DU transmission timing following the timing control command.

In some embodiments of this aspect, the adjustment of the MT transmission timing following the timing control command is aligned to the DU transmission timing at the child network node. In some embodiments of this aspect, the method further comprises receiving information about one of a requested adjustment of the MT transmission timing and an estimated propagation time from the child network node, the transmitted timing control command being based at least in part on the received information. In some embodiments of this aspect, the method further includes determining a timing offset between the MT and DU transmission timings based at least in part on a timing misalignment of at least one other network node.

According to yet another aspect, a network node comprising a memory and a processor, the memory comprising instructions and the processor configured to execute the instructions to perform any one or more of the methods above.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of IAB-MT and IAB-DU for backhaul and access link;

FIG. 2 illustrates an example of timing relations between an IAB node (the child node) and its parent node;

FIG. 3 illustrates an example of aligned DU and MT transmission timing at an IAB node;

FIG. 4 illustrates an example of aligned DU and MT TX timing at an IAB node according to Approach 1;

FIG. 5 illustrates an example of aligned DU and MT TX timing at an IAB node according to Approach 2;

FIG. 6 is a schematic diagram of an exemplary network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating exemplary methods implemented in a communication system including a host computer, a network node and a wireless device for executing a client application at a wireless device according to some embodiments of the present disclosure;

FIG. 9 is a flowchart illustrating exemplary methods implemented in a communication system including a host computer, a network node and a wireless device for receiving user data at a wireless device according to some embodiments of the present disclosure;

FIG. 10 is a flowchart illustrating exemplary methods implemented in a communication system including a host computer, a network node and a wireless device for receiving user data from the wireless device at a host computer according to some embodiments of the present disclosure;

FIG. 11 is a flowchart illustrating exemplary methods implemented in a communication system including a host computer, a network node and a wireless device for receiving user data at a host computer according to some embodiments of the present disclosure;

FIG. 12 is a flowchart of an exemplary process in a network node (e.g., IAB node) for adjustment unit according to some embodiments of the present disclosure;

FIG. 13 is a flowchart of an exemplary process in a network node (e.g., parent IAB node) for alignment unit according to some embodiments of the present disclosure;

FIG. 14 is a flowchart of an exemplary process in a network node (e.g., IAB node) for adjustment unit according to some embodiments of the present disclosure;

FIG. 15 is a flowchart of an exemplary process in a network node (e.g., parent IAB node) for alignment unit according to some embodiments of the present disclosure;

FIG. 16 illustrates an example of Embodiment 1 with a timing window indicating how much the DU TX timing can deviate from an ideal DU TX timing, according to some embodiments of the present disclosure;

FIG. 17 illustrates an example of MT transmission timing according to Embodiment 2 with two types of MT transmissions of different timing, according to some embodiments of the present disclosure;

FIG. 18 illustrates an example of Embodiment 2 with a window indicating how much the timing of MT transmissions type-2 can deviate from the MT transmissions type-1, according to some embodiments of the present disclosure; and

FIG. 19 illustrates an example of adjustment of the parent-node DU receive timing target to align IAB node MT and DU transmission timing according to Embodiment 3, according to some embodiments of the present disclosure.

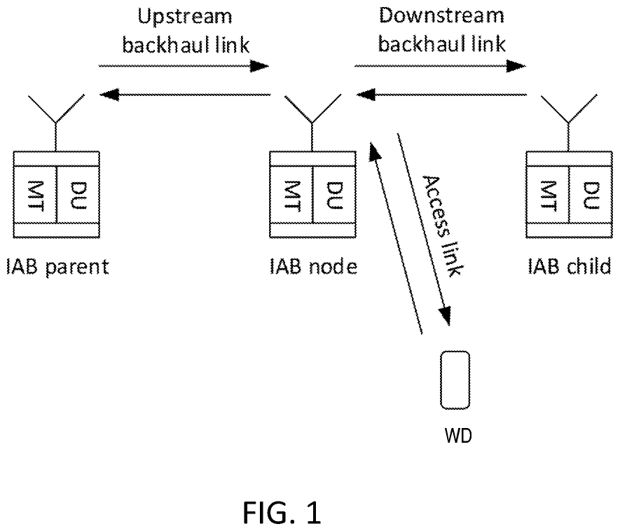

### DETAILED DESCRIPTION

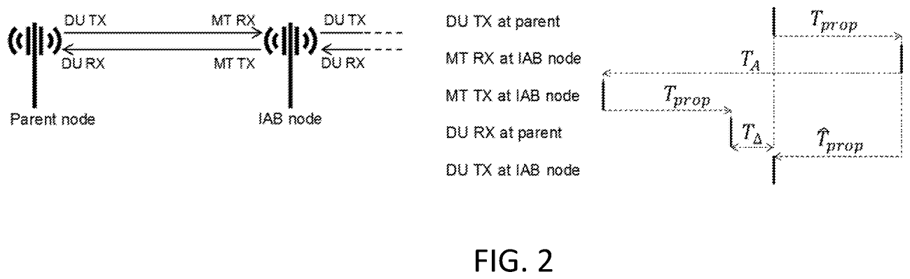

With the timing assumptions, an example of which is shown in FIG. 2, the transmit timing of the MT and DU of an IAB node are not mutually aligned. For the first release of 3GPP New Radio (NR) (also called 5^{th} Generation or 5G), the assumption has been that, at least in the typical case, the DU and MT transmissions of an IAB node are time multiplexed, which may make it less important for full alignment of the DU and MT transmissions (e.g., the mis-alignment between the DU and MT transmissions may be handle by guard symbols that are anyway used to provide time for switching between the DU and MT).

However, scenarios with simultaneous MT and DU transmission within a carrier are also contemplated. There are, in that case, two alternatives for the DU/MT multiplexing:
Frequency-division multiplexing (FDM), that is, simultaneous DU and MT transmissions that are separated in the frequency domain, for example, by transmission within different resources blocks within a carrier; and
Spatial-division multiplexing, (SDM), that is, simultaneous DU and MT transmissions that are separated in the spatial domain, for example, by transmitting within different beams or from different antenna panels pointing in different directions, within the same IAB node.

Both these arrangements of multiplexing DU and MT transmissions may be considered by a 3GPP Release-17 (Rel-17) work item on enhanced IAB.

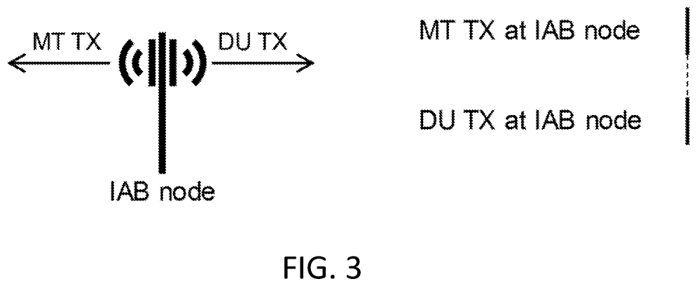

Simultaneous DU and MT transmission is, implementation-wise, simplified if the DU and MT transmission timings are mutually aligned as illustrated in FIG. 3, for example. However, as outlined above, this is typically not the case for IAB node DU and MT transmissions based on the Release 16 timing specifications.

Thus, there is a desire for new solutions that enable an IAB node to align the timing of its DU and MT transmissions. Such solutions may, at the same time, take into account, for example, the possible desire to:
Align, at least to some extent, DU transmissions between cells within a certain window; and/or
Align the reception, at a parent node, of different MT and WD transmissions within a certain window.

Some embodiments of the present disclosure may provide for one or more of the following three approaches for aligning the DU and MT transmission timings:

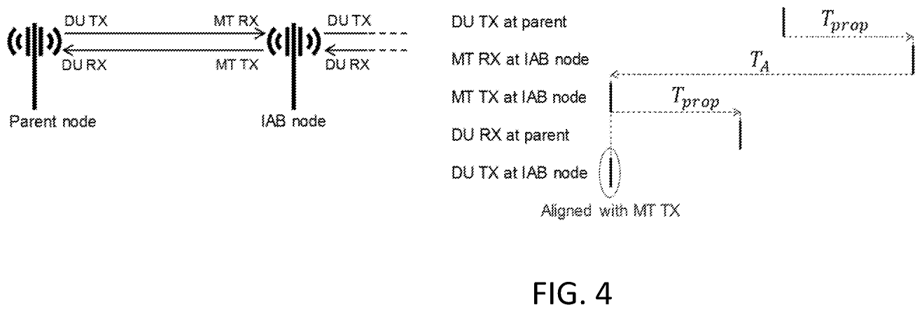

Approach 1: The MT transmission timing of the IAB node is controlled by the parent node as for current 3GPP Release 16, including not taking into account any specific desire to align the MT and DU transmission timings. The IAB node may then autonomously align the DU transmission timing to the MT transmission timing, see FIG. 4, for example. Arrangements may be taken so that the DU transmission timing does not deviate too much from, for example, the downlink transmission timing of other cells (including the DU transmission timing of its own parent). This may be addressed by embodiment 1, described in more detail below.

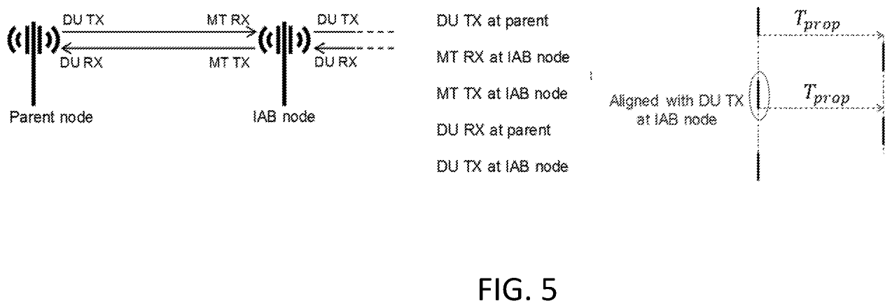

Approach 2: The DU transmission timing of the IAB node is, in one way or another, kept aligned with the parent DU TX timing, as for current (3GPP Release 16) OTA DU timing assumptions. The IAB node may then align the MT transmission timing to the DU transmission timing, an example of which is shown in FIG. 5. This implies that the parent IAB node does no longer have control of the MT transmission timing with possible mis-alignment in the parent-node reception timing of different MT and WD transmissions. This may be addressed by embodiment 2, described in more detail below.

Approach 3: The MT transmission timing is controlled by the parent IAB node as for current 3GPP Release 16, but taking into account, directly or indirectly, any desire to align the IAB node MT and DU transmission timing. This may be addressed by embodiment 3, described in more detail below.

Some embodiments of the present disclosure may advantageously provide tools for aligning the DU and MT transmission timings of an IAB node, thereby enabling more efficient FDM and/or SDM between the DU and MT transmissions. The transmission alignment is such that the impact on network operation, as well as, reception at parent nodes may be within acceptable limits.

Before describing in detail exemplary embodiments, it is noted that the embodiments reside primarily in combinations of apparatus components and processing steps related to aligning Distributed Unit/Mobile Termination (DU/MT) transmission timing. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication (e.g., an indication of a timing window, etc.) generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

The term “radio measurement” used herein may refer to any measurement performed on radio signals. Radio measurements can be absolute or relative. Radio measurement may be called as signal level which may be signal quality and/or signal strength. Radio measurements can be e.g. intra-frequency, inter-frequency, inter-RAT measurements, CA measurements, etc. Radio measurements can be unidirectional (e.g., DL or UL) or bidirectional (e.g., Round Trip Time (RTT), Receive-Transmit (Rx-Tx), etc.). Some examples of radio measurements: timing measurements (e.g., Time of Arrival (TOA), timing advance, RTT, Reference Signal Time Difference (RSTD), Rx-Tx, propagation delay, etc.), angle measurements (e.g., angle of arrival), power-based measurements (e.g., received signal power, Reference Signals Received Power (RSRP), received signal quality, Reference Signals Received Quality (RSRQ), Signal-to-interference-plus-noise Ratio (SINR), Signal Noise Ratio (SNR), interference power, total interference plus noise, Received Signal Strength Indicator (RSSI), noise power, etc.), cell detection or cell identification, radio link monitoring (RLM), system information (SI) reading, etc. The inter-frequency and inter-RAT measurements are carried out by the WD in measurement gaps unless the WD is capable of doing such measurement without gaps. Examples of measurement gaps are measurement gap id #0 (each gap of 6 ms occurring every 40 ms), measurement gap id #1 (each gap of 6 ms occurring every 80 ms), etc. The measurement gaps are configured at the WD by the network node.

A cell may be generally a communication cell, e.g., of a cellular or mobile communication network, provided by a node. A serving cell may be a cell on or via which a network node (the node providing or associated to the cell, e.g., base station or gNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state. e.g., in case the node and/or user equipment and/or network follow the NR-standard. One or more carriers (e.g., uplink and/or downlink carrier/s and/or a carrier for both uplink and downlink) may be associated to a cell.

The term “node” is used herein and may indicate an IAB node. In some embodiments, the terms “child” and “descendent” are used interchangeably. The shortened terms “parent”, “child” and “donor” may be used to indicate a parent IAB node, a child IAB node and an IAB donor node, respectively.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for arrangements for aligning Distributed Unit/Mobile Termination (DU/MT) transmission timing.

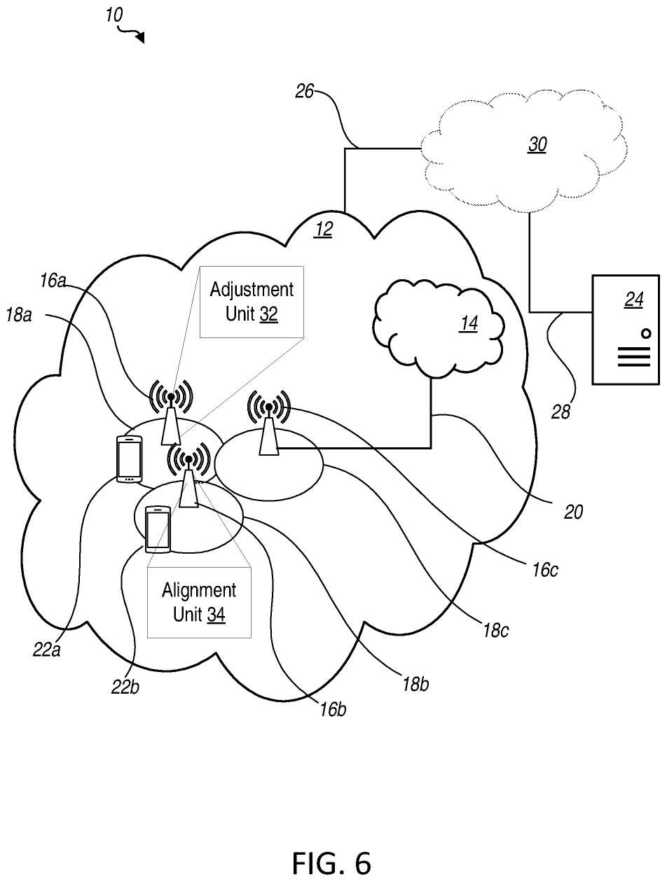

Referring now to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

In some embodiments, a network node 16 is configured to include an adjustment unit 32 which is configured to optionally, receive a command related to timing alignment from a parent node; and adjust a Distributed Unit (DU) transmission timing to align with at least one Mobile Terminated Unit (MT) transmission timing based at least in part on the command.

In some embodiments, a network node 16 is configured to include an alignment unit 34 which is configured to send a command related to timing alignment to a child node; and receive a transmission based at least in part on a timing, the timing being adjusted to align the child node's Distributed Unit (DU) transmission timing with at least one Mobile Terminated Unit (MT) transmission timing based at least in part on the command.

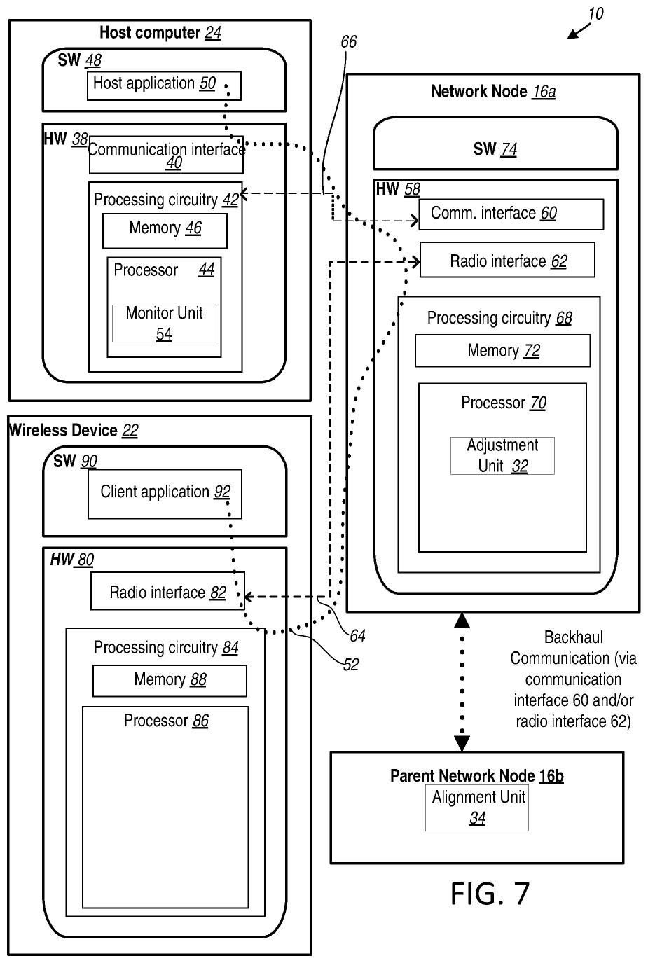

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

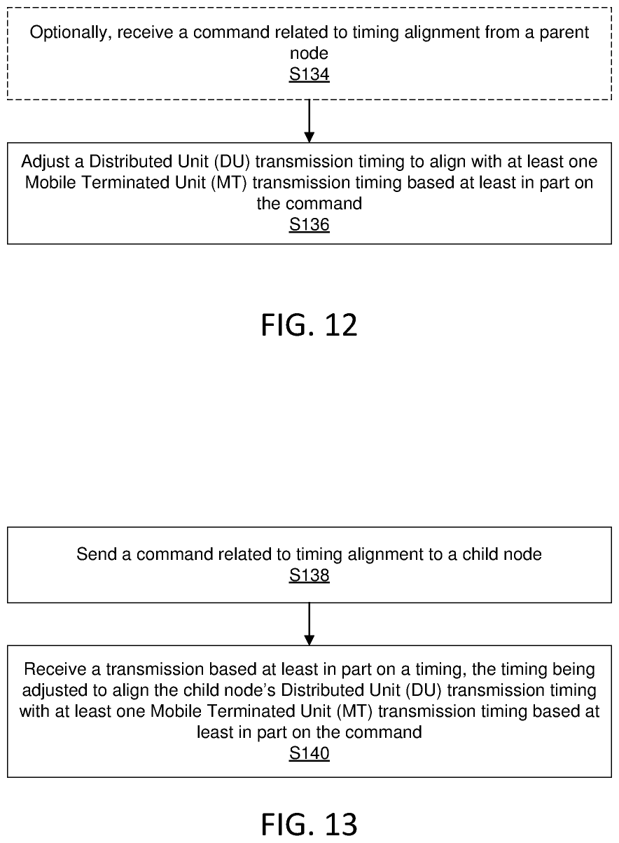

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include adjustment unit 32 and/or alignment unit 34 configured to perform network node methods discussed herein, such as the methods discussed with reference to FIGS. 12, 13, 14, 15 as well as, other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as adjustment unit 32, and alignment unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry. In addition, such units, e.g., mobile terminated unit and distributed unit in a respective IAB network node may be associated with one or more corresponding radio interfaces for the transmission and reception described herein.

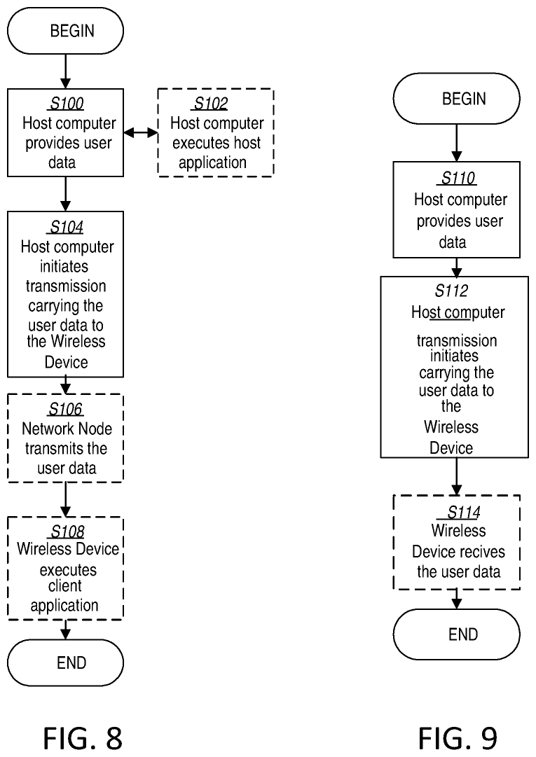

FIG. 8 is a flowchart illustrating an exemplary method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

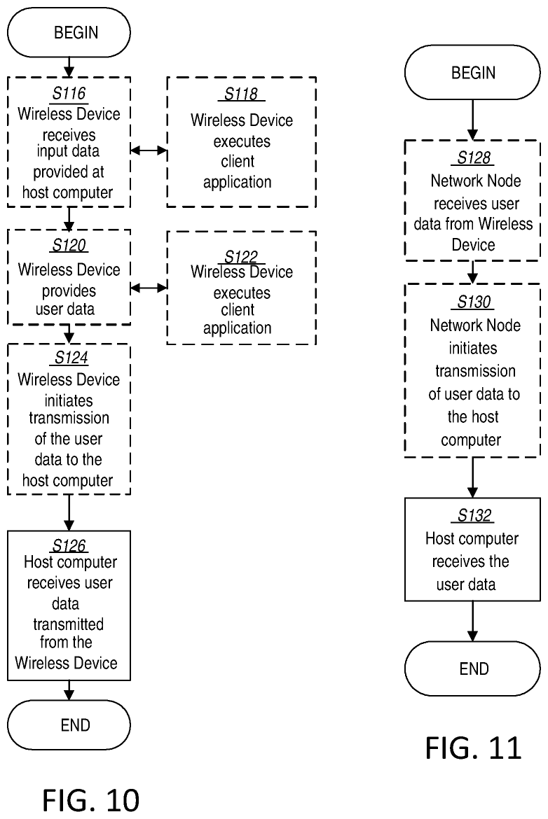

FIG. 10 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an exemplary method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 12 is a flowchart of an exemplary process in a network node 16 (e.g., network node 16a, child IAB node) according to some embodiments of the present disclosure. One or more Blocks and/or functions and/or methods performed by the network node 16 may be performed by one or more elements of network node 16 such as by adjustment unit 32 in processing circuitry 68, processor 70, radio interface 62, etc. according to the example method. The example method includes optionally, receiving (Block S134), such as via adjustment unit 32, processing circuitry 68, processor 70, communication interface 60 and/or radio interface 62, a command related to timing alignment from a parent node. The method includes adjusting (Block S136), such as via adjustment unit 32, processing circuitry 68, processor 70, communication interface 60 and/or radio interface 62, a Distributed Unit (DU) transmission timing to align with at least one Mobile Terminated Unit (MT) transmission timing based at least in part on the received command.

In some embodiments, the command indicates a timing window. In some embodiments, the timing window is based at least in part on an output power associated with the DU. In some embodiments, the adjusting the DU transmission timing to align with the at least one MT transmission timing further includes adjusting, such as via adjustment unit 32, processing circuitry 68, processor 70, communication interface 60 and/or radio interface 62, the DU transmission timing based on two different types of MT transmissions, a first type following a timing control command from the parent node and a second type being aligned with the DU transmission timing. In some embodiments, the method further includes signaling, such as via adjustment unit 32, processing circuitry 68, processor 70, communication interface 60 and/or radio interface 62, a requested adjustment of the MT transmission timing to the parent node; and/or determining, such as via adjustment unit 32, processing circuitry 68, processor 70, communication interface 60 and/or radio interface 62, a timing offset based at least in part on a timing misalignment of at least one other node.

FIG. 13 is a flowchart of an exemplary process in a network node 16 (e.g., network node 16b, parent IAB node) according to some embodiments of the present disclosure. One or more Blocks and/or functions and/or methods performed by the network node 16 may be performed by one or more elements of network node 16 such as by alignment unit 34 in processing circuitry 68, processor 70, communication interface 60, radio interface 62, etc. according to the example method. The example method includes sending (Block S138), such as via alignment unit 34, processing circuitry 68, processor 70, communication interface 60 and/or radio interface 62, a command related to timing alignment to a child node. The method includes receiving (Block S140), such as via alignment unit 34, processing circuitry 68, processor 70, communication interface 60 and/or radio interface 62, a transmission based at least in part on a timing, the timing being adjusted to align the child node's Distributed Unit (DU) transmission timing with at least one Mobile Terminated Unit (MT) transmission timing based at least in part on the command.

In some embodiments, the command indicates a timing window. In some embodiments, the timing window is based at least in part on an output power associated with the DU. In some embodiments, the timing is adjusted to align the child node's DU transmission timing based on two different types of MT transmissions, a first type following a timing control command from the network node and a second type being aligned with the DU transmission timing. In some embodiments, the method further includes receiving, such as via alignment unit 34, processing circuitry 68, processor 70, communication interface 60 and/or radio interface 62, a requested adjustment of the MT transmission timing from the child node. In some embodiments, the method includes determining, such as via alignment unit 34, processing circuitry 68, processor 70, communication interface 60 and/or radio interface 62, a timing offset based at least in part on a timing misalignment of at least one other node.

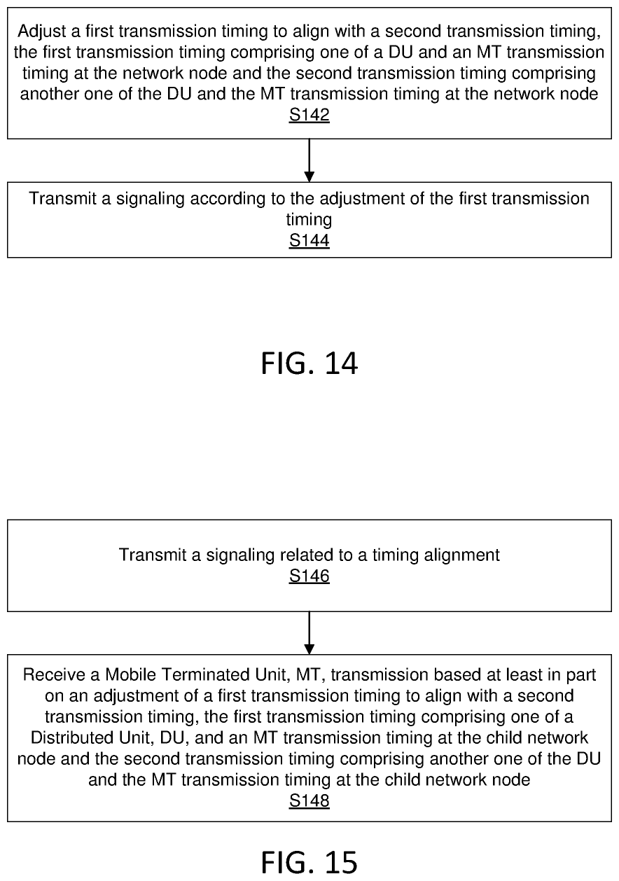

FIG. 14 is a flowchart of an exemplary process in a network node 16 (e.g., network node 16a, child IAB node) according to some embodiments of the present disclosure. One or more Blocks and/or functions and/or methods performed by the network node 16 may be performed by one or more elements of network node 16 such as by adjustment unit 32 in processing circuitry 68, processor 70, communication interface 60, radio interface 62, etc. according to the example method. The example method is implemented in a network node 16 configured to communicate with a parent network node 16 over a backhaul network. The network node 16 comprises a Mobile Terminated Unit, MT, and a Distributed Unit, DU. The method comprises adjusting (Block S142), such as by adjustment unit 32 in processing circuitry 68, processor 70, communication interface 60 and/or radio interface 62, a first transmission timing to align with a second transmission timing, the first transmission timing comprising one of a DU and an MT transmission timing at the network node and the second transmission timing comprising another one of the DU and the MT transmission timing at the network node. The method includes transmitting (Block S144), such as by adjustment unit 32 in processing circuitry 68, processor 70, communication interface 60 and/or radio interface 62, a signaling according to the adjustment of the first transmission timing.

In some embodiments, the method further includes performing, such as by adjustment unit 32 in processing circuitry 68, processor 70, communication interface 60 and/or radio interface 62, by the MT comprised in the network node 16, an MT transmission to the parent network node. In some embodiments, transmitting the signaling comprises transmitting, by the DU comprised in the network node, such as by adjustment unit 32 in processing circuitry 68, processor 70, communication interface 60 and/or radio interface 62, a DU transmission to one of a child network node and a user equipment, UE, the MT and DU transmissions at the network node being timing aligned according to the adjustment of the first transmission timing.

In some embodiments, the first and second transmissions are one of frequency-division multiplexed and spatial-division multiplexed. In some embodiments, the adjustment of the first transmission timing comprises an adjustment of the DU transmission timing to align with the MT transmission timing. In some embodiments, the adjustment of the DU transmission timing to align with the MT transmission timing is based at least in part on a timing window. In some embodiments, the method further includes receiving, such as by adjustment unit 32 in processing circuitry 68, processor 70, communication interface 60 and/or radio interface 62, a command comprising the timing window from one of the parent network node, a centralized unit, CU, and an operations, administration, and maintenance, OAM, function.

In some embodiments, the timing window indicates an amount of deviation allowed for the DU transmission timing relative to an ideal timing alignment of the DU transmission timing to the MT transmission timing. In some embodiments, the timing window is one of symmetric and asymmetric about the ideal timing alignment. In some embodiments, the timing window is based at least in part on an output power associated with the DU. In some embodiments, the method further includes transmitting, such as by adjustment unit 32 in processing circuitry 68, processor 70, communication interface 60 and/or radio interface 62, an indication of the output power associated with the DU to the parent network node and receiving a command comprising the timing window based on the transmitted indication of the output power.

In some embodiments, the method further includes receiving, such as by adjustment unit 32 in processing circuitry 68, processor 70, communication interface 60 and/or radio interface 62, a broadcast comprising a plurality of timing windows associated with a plurality of output power values. In some embodiments, the method further includes receiving, such as by adjustment unit 32 in processing circuitry 68, processor 70, communication interface 60 and/or radio interface 62, a command comprising a reference window for a reference output power and deriving the timing window from the reference window, the reference output power and an actual output power associated with the DU. In some embodiments, the adjustment of the first transmission timing comprises an adjustment of an MT transmission timing to align with a DU transmission timing is based at least in part on two different types of MT transmission timings, a first type of MT transmission timing following a timing control command from the parent network node and a second type of MT transmission timing aligning to the DU transmission timing at the network node.

In some embodiments, the first type of MT transmission timing following the timing control command is not aligned to the DU transmission timing at the network node. In some embodiments, the first type of MT transmission timing is based at least in part on a relation between the first and second types of MT transmission timings. In some embodiments, the relation is one of derived by and signaled to the parent network node. In some embodiments, the adjustment of the MT transmission timing to align with the DU transmission timing is based at least in part on a timing window. In some embodiments, the method further includes receiving, such as by adjustment unit 32 in processing circuitry 68, processor 70, communication interface 60 and/or radio interface 62, a command comprising the timing window from one of the parent network node, a centralized unit, CU, and an operations, administration, and maintenance, OAM, function.

In some embodiments, the timing window indicates an amount of deviation allowed for the second type of MT transmission timing relative to the first type of MT transmission timing. In some embodiments, the timing window is one of symmetric and asymmetric about the first type of MT transmission timing. In some embodiments, the adjustment of the first transmission timing comprises an adjustment of an MT transmission timing to align with a DU transmission timing following a timing control command from the parent network node. In some embodiments, the adjustment of the MT transmission timing following the timing control command is aligned to the DU transmission timing at the network node. In some embodiments, the method further includes signaling information about one of a requested adjustment of the MT transmission timing and an estimated propagation time to the parent network node, the timing control command being based at least in part on the signaled information. In some embodiments, the method further includes determining, such as by adjustment unit 32 in processing circuitry 68, processor 70, communication interface 60 and/or radio interface 62, a timing offset between the MT and DU transmission timings based at least in part on a timing misalignment of at least one other network node.

FIG. 15 is a flowchart of an exemplary process in a network node 16 (e.g., network node 16b, parent IAB node) according to some embodiments of the present disclosure. One or more Blocks and/or functions and/or methods performed by the network node 16 may be performed by one or more elements of network node 16 such as by alignment unit 34 in processing circuitry 68, processor 70, communication interface 60, radio interface 62, etc. according to the example method. The example method is implemented in a network node configured to communicate with a child network node over a backhaul network. The method comprises transmitting (Block S146), such as by alignment unit 34 in processing circuitry 68, processor 70, communication interface 60 and/or radio interface 62, a signaling related to a timing alignment. The method includes receiving (Block S148), such as by alignment unit 34 in processing circuitry 68, processor 70, communication interface 60, radio interface 62, a Mobile Terminated Unit, MT, transmission based at least in part on an adjustment of a first transmission timing to align with a second transmission timing, the first transmission timing comprising one of a Distributed Unit, DU, and an MT transmission timing at the child network node and the second transmission timing comprising another one of the DU and the MT transmission timing at the child network node.

In some embodiments, the MT transmission received from the child network node is one of frequency-division multiplexed and spatial-division multiplexed with a DU transmission at the child network node. In some embodiments, the adjustment of the first transmission timing comprises an adjustment of the DU transmission timing to align with the MT transmission timing. In some embodiments, the adjustment of the DU transmission timing to align with the MT transmission timing is based at least in part on a timing window. In some embodiments, transmitting the signaling comprises transmitting such as by alignment unit 34 in processing circuitry 68, processor 70, communication interface 60, radio interface 62, a command comprising the timing window. In some embodiments, the timing window indicates an amount of deviation allowed for the DU transmission timing relative to an ideal timing alignment of the DU transmission timing to the MT transmission timing.

In some embodiments, the timing window is one of symmetric and asymmetric about the ideal timing alignment. In some embodiments, the timing window is based at least in part on an output power associated with the DU comprised in the child network node. In some embodiments, the method further includes receiving such as by alignment unit 34 in processing circuitry 68, processor 70, communication interface 60, radio interface 62, an indication of the output power associated with the DU comprised in the child network node; and wherein transmitting the signaling comprises transmitting a command comprising the timing window based on the received indication of the output power. In some embodiments, transmitting the signaling comprises transmitting such as by alignment unit 34 in processing circuitry 68, processor 70, communication interface 60, radio interface 62, a broadcast comprising a plurality of timing windows associated with a plurality of output power values.

In some embodiments, transmitting the signaling comprises transmitting such as by alignment unit 34 in processing circuitry 68, processor 70, communication interface 60, radio interface 62, a command comprising a reference window for a reference output power, the timing window being derived at the child network node from the reference window, the reference output power and an actual output power associated with the DU comprised in the child network node. In some embodiments, the adjustment of the first transmission timing comprises an adjustment of an MT transmission timing to align with a DU transmission timing based at least in part on two different types of MT transmission timings, a first type of MT transmission timing following a timing control command from the network node and a second type of MT transmission timing aligning to the DU transmission timing at the child network node. In some embodiments, the first type of MT transmission timing following the timing control command is not aligned to the DU transmission timing at the child network node.

In some embodiments, the first type of MT transmission timing is based at least in part on a relation between the first and second types of MT transmission timings. In some embodiments, the relation is one of derived by the network node and received from the child network node. In some embodiments, the adjustment of the MT transmission timing to align with the DU transmission timing is based at least in part on a timing window. In some embodiments, transmitting the signaling comprises transmitting such as by alignment unit 34 in processing circuitry 68, processor 70, communication interface 60, radio interface 62, a command comprising the timing window. In some embodiments, the timing window indicates an amount of deviation allowed for the second type of MT transmission timing relative to the first type of MT transmission timing.

In some embodiments, the timing window is one of symmetric and asymmetric about the first type of MT transmission timing. In some embodiments, transmitting the signaling comprises transmitting such as by alignment unit 34 in processing circuitry 68, processor 70, communication interface 60, radio interface 62, a timing control command to the child network node, the adjustment of the first transmission timing comprises an adjustment of an MT transmission timing to align with a DU transmission timing following the timing control command. In some embodiments, the adjustment of the MT transmission timing following the timing control command is aligned to the DU transmission timing at the child network node. In some embodiments, the method further includes receiving, such as by alignment unit 34 in processing circuitry 68, processor 70, communication interface 60, radio interface 62, information about one of a requested adjustment of the MT transmission timing and an estimated propagation time from the child network node, the transmitted timing control command being based at least in part on the received information. In some embodiments, the method further includes determining, such as by alignment unit 34 in processing circuitry 68, processor 70, communication interface 60, radio interface 62, a timing offset between the MT and DU transmission timings based at least in part on a timing misalignment of at least one other network node.

Having described the general process flow of arrangements of the disclosure and having provided examples of hardware and software arrangements for implementing the processes and functions of the disclosure, the sections below provide details and examples of arrangements for aligning Distributed Unit/Mobile Termination (DU/MT) transmission timing, which may be implemented by the network node 16, wireless device 22 and/or host computer 24.

### Embodiment 1

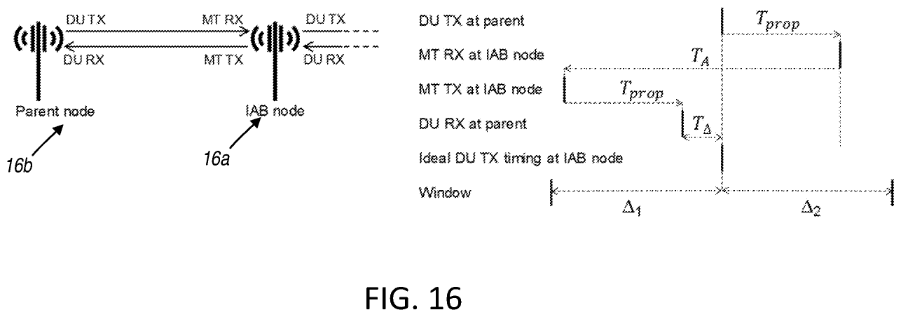

In some aspects, embodiment 1 may be related to approach 1 discussed above. That is, the IAB node (e.g., network node 16a) may adjust the DU timing to align the DU timing with the MT transmission timing, where the MT transmission timing may be controlled by timing alignment commands from the parent IAB node (e.g., network node 16b). For the network to still be able to have a certain control of the DU transmission timing, for example, to ensure that the DU transmission timing does not deviate too much from the parent IAB node DU transmission timing, some embodiments provide that the IAB node (e.g., network node 16a) is provided with a timing window (e.g., by parent IAB node, pre-configured/predetermined by a standard). The timing window may indicate how much the IAB node can deviate from a predetermined timing, such as an “ideal timing.” Reference is made to FIG. 16 which illustrates an example of embodiment 1 with a timing window indicating how much the DU transmitter (TX) timing can deviate from a predetermining timing e.g., an ideal DU TX timing. The ideal and/or predetermined timing could, for example, be the DU transmission timing according to current 3GPP Release 16.

In some embodiments, the timing window may be asymmetric, which may imply that the DU transmission timing can deviate from e.g., −Δ₁ to Δ₂ from the ideal and/or predetermined timing, see FIG. 16 for example. In this case, the window is thus given by two parameters Δ₁ and Δ₂.

Alternatively, in some embodiments, the timing window may be symmetric, which may imply that the DU transmission timing can deviate a time ±Δ from the ideal and/or predetermined timing. In this case, the timing window is thus given by a single parameter Δ. This case may correspond to FIG. 16 where Δ₁=Δ₂=Δ.

Thus, the IAB node (e.g., network node 16a) can fully align DU transmitter (TX) timing to the MT TX timing only if the DU TX timing would still fall within the provided timing window. Also, in some embodiments, if the parent IAB node (e.g., network node 16b) decides, it can set the window to a very small size around the ideal DU transmission timing, thereby restricting the DU transmission timing to the current 3GPP Release 16 DU transmission timing.

In some embodiments, the timing window may be provided to the IAB node (e.g., network node 16a) by dedicated signaling provided by/via the parent IAB node (e.g., network node 16b) when the IAB node MT has connected to the network. Alternatively, in some embodiments, the timing window may be provided by broadcasting IAB-related system information provided by the parent IAB node (e.g., network node 16b). Information about the timing window may also be provided by the IAB node's (e.g., network node 16a) CU and/or other centralized or distributed functions, such as Operations and Maintenance (OAM).

In some embodiments, the timing window may depend on a maximum output power of the IAB node DU, where the output power could be the specified maximum output power of the IAB node (e.g., network node 16a). Alternatively, in some embodiments, the output power used to determine the timing window may be lower than the specified maximum output power of the IAB node (e.g., network node 16a). In some embodiments, the lower output power may be determined on by the IAB node (e.g., network node 16a) itself. Alternatively, the lower output power may be signaled to the IAB node (e.g., network node 16a).

In some embodiments, a size of the timing window may, for example, be larger in case of lower output power of the IAB node DU (e.g., network node 16a). In case of broadcast of the timing window, this may imply the broadcast of multiple timing windows, where each timing window may be associated with a certain IAB node DU transmit power or a range of IAB-node DU transmit powers. The same could be used in case of dedicated signaling. Alternatively, in the case of dedicated signaling, the IAB node (e.g., network node 16a) may provide its DU output power to the network and the network then provides a single timing window, where the timing window that is provided may depend on the DU transmit power provided by the IAB node (e.g., network node 16a).

In some embodiments, an IAB node (e.g., network node 16a) may also be provided information of a reference window for a reference output power. In this case, the effective window may be derived, e.g., by network node 16a, from the reference window and output power by a node-internal function applying a mathematical operation on these parameters, such as linear interpolation to the actual output power.

### Embodiment 2

In some aspects, embodiment 2 is related to approach 2 described above. That is, the MT timing is adjusted, e.g., by network node 16a to align with the DU transmission timing.

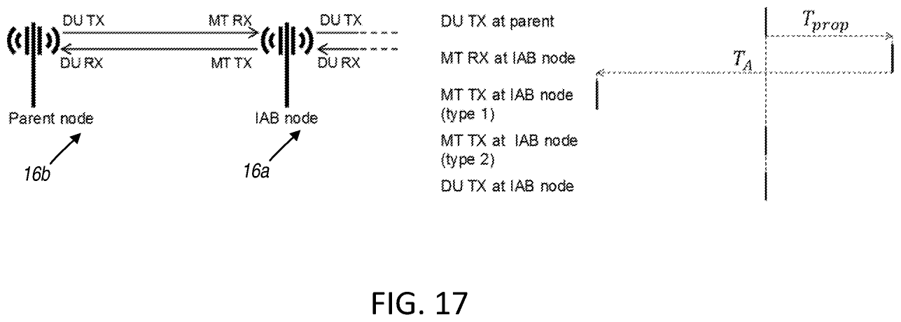

In some aspects of embodiment 2, the IAB node (e.g., network node 16a) carries out two different types of MT transmissions, herein referred to as MT transmission type-1 and MT transmission type-2, respectively, an example of which is shown in FIG. 17.

In some embodiments, MT transmissions of type-1 follow timing control commands by the parent IAB node (e.g., network node 16b) as for current NR specifications. MT transmissions of type-1 may thus typically not be aligned with the IAB node DU transmissions. The MT transmissions of type-1 may occur with a low duty cycle and may, as one example, include transmission for measurement purposes, such as SRS (Sounding Reference Signals) as defined for current NR.

In some embodiments, MT transmissions of type-2 are not aligned with MT transmissions of type-1. Instead, the IAB node (e.g., network node 16a) may, for example, align the timing of MT transmissions of type-2, with the timing of its DU transmissions as illustrated in FIG. 17 for example. The MT transmissions of type-2 may constitute a main part of the MT transmissions.

In some embodiments, in order for the parent IAB node (e.g., network node 16b) to be able to provide the IAB node (e.g., network node 16a) with time-alignment commands for type-1 transmission, measurements of the reception timing at the parent IAB node (e.g., network node 16b) may preferably be carried out on MT transmissions of type-1. If the parent IAB node (e.g., network node 16b) has information about the intended relation, e.g. difference, of type-1 and type-2 transmission timing of the IAB node, the parent IAB node's (e.g., network node 16b) determination of time-alignment commands for type-1 transmission can be assisted by measurements of the reception timing of type-2 transmissions, if adjusted by the assumed type-1 and type-2 transmission timing relation. This information about the relation of type-1 and type-2 transmission can be derived by the parent IAB node (e.g., network node 16b) (e.g. by knowing that MT transmissions of type-2 are time aligned with the IAB node DU transmissions, which may be time aligned with parent DU transmission), or by the IAB node (e.g., network node 16a) signaling this information to the parent IAB node (e.g., network node 16b).

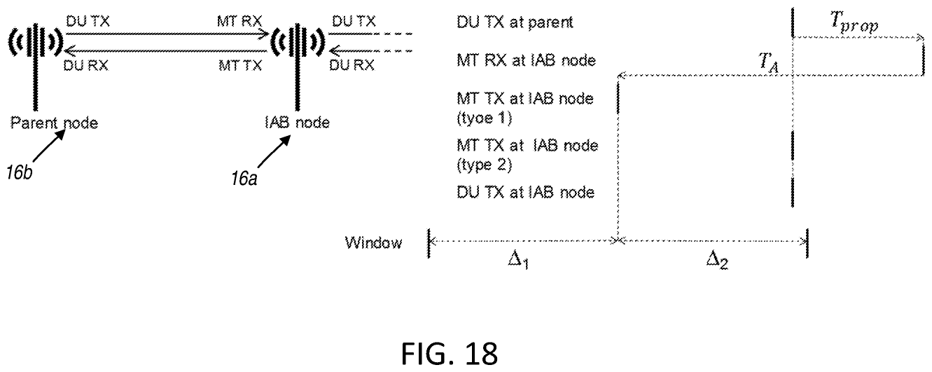

In order to ensure that MT transmissions of type-2 are not received with too much timing mis-alignment at the parent IAB node (e.g., network node 16b), relative to other signals received by the parent IAB node (e.g., network node 16b), the IAB node (e.g., network node 16a) can be provided with a timing window that indicates how much the transmission timing of MT transmissions of type-2 is allowed to deviate from the parent-controlled transmission timing of MT transmissions of type-1, an example of which can be seen in FIG. 18.
The timing window can be asymmetric, implying that timing of MT transmission type-2 can deviate from −Δ₁ to Δ₂ relative to MT transmissions type-1, see FIG. 18. In this case, the timing window is thus given by two, different parameters Δ₁ and Δ₂.
Alternatively, the timing window can be a symmetric, implying that the timing of MT transmission type-2 can deviate a time ±Δ from the timing of MT transmissions type-1. In this case, the timing window is thus given by a single parameter Δ. This case corresponds to FIG. 18, where Δ₁=Δ₂=A.

In some embodiments, the timing window may either be provided to the IAB node (e.g., network node 16a) by dedicated signaling provided by/via the parent IAB node (e.g., network node 16b) when the IAB node MT has connected to the network. Alternatively, the timing window could be provided by broadcast IAB-related system information. Information about the timing window can also be provided by the parent IAB node's CU and/or other centralized or distributed functions, such as OAM.

In some embodiments, MT transmissions type-2 can for example be limited to a subset of the slots available for MT transmission.

In order for the parent IAB node (e.g., network node 16b) to receive transmissions based on either type-1 or type-2 transmissions, the IAB node (e.g., network node 16a) may further signal its determined actual difference between type-1 and type-2 transmission timings, Δ_{actual}, to the parent IAB node (e.g., network node 16b).

### Embodiment 3

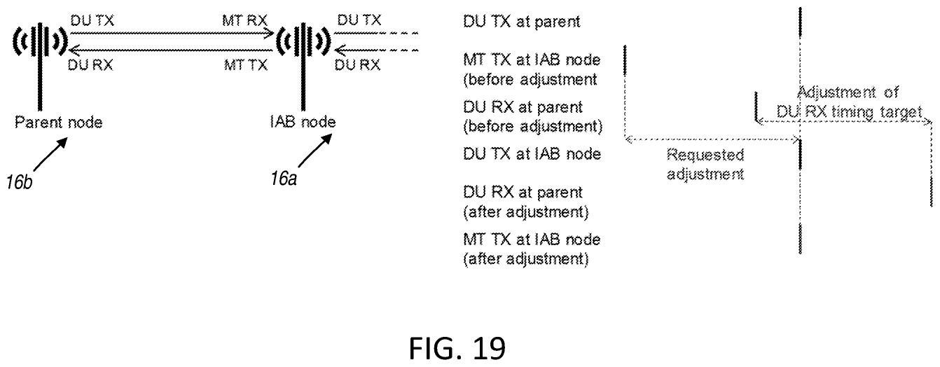

In some aspects, embodiment 3 may be considered to be related to approach 3 above. In some embodiments, the parent IAB node (e.g., network node 16b) adjusts its control of the IAB node MT transmission timing to assist the IAB node (e.g., network node 16a) in aligning the timing of the DU transmission and MT transmission. This can be done by, for example, the IAB node (e.g., network node 16a) signaling to the parent IAB node (e.g., network node 16b) a requested adjustment of the MT transmission timing. Based on this, the parent IAB node (e.g., network node 16b) adjusts its target received timing for the IAB node MT transmission, an example of which is shown in FIG. 19. In some embodiments, the adjustment of the target received timing may be the same as the requested timing adjustment. Alternatively, the adjustment of the target received timing may be less than the requested timing adjustment.

Alternatively, or additionally, instead of signaling a requested timing adjustment, the IAB node (e.g., network node 16a) may signal its estimated propagation time, based on which, the parent IAB node (e.g., network node 16b) may conclude on an adjustment of the target received timing.

In some embodiments, if the MT transmission timing based on the parent IAB node (e.g., network node 16b) adjusted timing control is not aligned, e.g., fully aligned with the DU transmission timing, the IAB node (e.g., network node 16a) can adjust/finetune the DU transmission timing to align it with the adjusted MT transmission timing, in the same way as for embodiment 1 above. The benefit, compared to embodiment 1, may be that the adjustment of the DU transmission timing may be kept smaller.

Selection of DU/MT Time Alignment Among Multiple Nodes

In all or some of the embodiments described above, the IAB node DU/MT timing misalignment may be restricted. However, a preferred timing may be set to match the parent IAB node (e.g., network node 16b). Alternatively, or additionally, the preferred timing, within the configured restrictions, may in some cases, e.g. embodiment 1, be determined based on multiple surrounding nodes. An argument for that is to make the IAB functionality transparent from the WD 22 perspective. Hence, to keep for example a DU TX timing within 3 μs also in relation to other network nodes or cells, the chosen timing misalignment may be chosen also taking into account other nodes. One alternative of this may be to use a weighted average of the timing misalignments among multiple surrounding cells to determine a preferred timing offset. In some embodiments, the weighting may in turn depend on received power from said cells, or an inter-site distance (ISD), if known. Another alternative may be to select the timing change such that as many as possible of the closest nodes to fall within the determined timing misalignment. In this sense, “closest” may be determined directly by knowledge of network node, e.g., gNB, locations, or indirectly from, e.g., reference signal received power (RSRP) measurements.

Some embodiments may include one or more of the following:

It is noted that the “nodes” referred to below may be IAB nodes.

Embodiment A1. A network node configured to communicate with at least one parent node over a backhaul network, the network node configured to, and/or comprising a radio interface and/or comprising processing circuitry configured to:
optionally, receive a command related to timing alignment from a parent node; and
adjust a Distributed Unit (DU) transmission timing to align with at least one Mobile Terminated Unit (MT) transmission timing based at least in part on the command.

Embodiment A2. The network node of Embodiment A1, wherein:
the command indicates a timing window; and/or
the timing window is based at least in part on an output power associated with the DU.

Embodiment A3. The network node of any one of Embodiments A1 and A2, wherein the network node and/or the radio interface and/or the processing circuitry is configured to adjust the DU transmission timing to align with the at least one MT transmission timing by being further configured to:
adjust the DU transmission timing based on two different types of MT transmissions, a first type following a timing control command from the parent node and a second type being aligned with the DU transmission timing.

Embodiment A4. The network node of any one of Embodiments A1-A3, wherein the network node and/or the radio interface and/or the processing circuitry is further configured to one or more of
signal a requested adjustment of the MT transmission timing to the parent node; and/or
determine a timing offset based at least in part on a timing misalignment of at least one other node.

Embodiment B1. A method implemented in a network node configured to communicate with at least one parent node over a backhaul network, the method comprising:
optionally, receiving a command related to timing alignment from a parent node; and
adjusting a Distributed Unit (DU) transmission timing to align with at least one Mobile Terminated Unit (MT) transmission timing based at least in part on the command.

Embodiment B2. The method of Embodiment B1, wherein:
the command indicates a timing window; and/or
the timing window is based at least in part on an output power associated with the DU.

Embodiment B3. The method of any one of Embodiments B1 and B2, wherein the adjusting the DU transmission timing to align with the at least one MT transmission timing further comprises:
adjusting the DU transmission timing based on two different types of MT transmissions, a first type following a timing control command from the parent node and a second type being aligned with the DU transmission timing.

Embodiment B4. The method of any one of Embodiments B1-B3, further comprising one or more of:
signaling a requested adjustment of the MT transmission timing to the parent node; and/or
determining a timing offset based at least in part on a timing misalignment of at least one other node.

Embodiment C1. A network node configured to communicate with at least one child node over a backhaul network, the network node configured to, and/or comprising a radio interface and/or comprising processing circuitry configured to:
send a command related to timing alignment to a child node; and
receive a transmission based at least in part on a timing, the timing being adjusted to align the child node's Distributed Unit (DU) transmission timing with at least one Mobile Terminated Unit (MT) transmission timing based at least in part on the command.

Embodiment C2. The network node of Embodiment C1, wherein:
the command indicates a timing window; and/or
the timing window is based at least in part on an output power associated with the DU.

Embodiment C3. The network node of any one of Embodiments C1 and C2, wherein the timing is adjusted to align the child node's DU transmission timing based on two different types of MT transmissions, a first type following a timing control command from the network node and a second type being aligned with the DU transmission timing.

Embodiment C4. The network node of any one of Embodiments C1-C3, wherein the network node and/or the radio interface and/or the processing circuitry is further configured to one or more of
receive a requested adjustment of the MT transmission timing from the child node; and/or
determine a timing offset based at least in part on a timing misalignment of at least one other node.

Embodiment D1. A method implemented in a network node configured to communicate with at least one child node over a backhaul network, the method comprising:
sending a command related to timing alignment to a child node; and
receiving a transmission based at least in part on a timing, the timing being adjusted to align the child node's Distributed Unit (DU) transmission timing with at least one Mobile Terminated Unit (MT) transmission timing based at least in part on the command.

Embodiment D2. The method of Embodiment D1, wherein:
the command indicates a timing window; and/or
the timing window is based at least in part on an output power associated with the DU.

Embodiment D3. The method of any one of Embodiments D1 and D2, wherein the timing is adjusted to align the child node's DU transmission timing based on two different types of MT transmissions, a first type following a timing control command from the network node and a second type being aligned with the DU transmission timing.

Embodiment D4. The method of any one of Embodiments D1-D3, further comprising one or more of:
receiving a requested adjustment of the MT transmission timing from the child node; and/or
determining a timing offset based at least in part on a timing misalignment of at least one other node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A method implemented in a network node configured to communicate with a parent network node over a backhaul network, the network node comprising a Mobile Terminated Unit, MT, and a Distributed Unit, DU, and the method comprising:
adjusting a first transmission timing to align with a second transmission timing, the first transmission timing comprising one of a DU and an MT transmission timing at the network node and the second transmission timing comprising another one of the DU and the MT transmission timing at the network node; and
transmitting a signaling according to the adjustment of the first transmission timing.

2. The method of claim 1, further comprising:
performing, by the MT comprised in the network node, an MT transmission to the parent network node; and
wherein transmitting the signaling comprises transmitting, by the DU comprised in the network node, a DU transmission to one of a child network node and a user equipment, UE, the MT and DU transmissions at the network node being timing aligned according to the adjustment of the first transmission timing.

3. The method of claim 1, wherein the first and second transmissions are one of frequency-division multiplexed and spatial-division multiplexed.

4. The method of claim 1, wherein the adjustment of the first transmission timing comprises an adjustment of the DU transmission timing to align with the MT transmission timing, the adjustment of the DU transmission timing to align with the MT transmission timing is based at least in part on a timing window.

5. (canceled)

6. The method of claim 5, further comprising receiving a command comprising the timing window from one of the parent network node, a centralized unit, CU, and an operations, administration, and maintenance, OAM, function.

7. The method of claim 5, wherein the timing window indicates an amount of deviation allowed for the DU transmission timing relative to an ideal timing alignment of the DU transmission timing to the MT transmission timing.

8. The method of claim 7, wherein the timing window is one of symmetric and asymmetric about the ideal timing alignment.

9. The method of claim 5, wherein the timing window is based at least in part on an output power associated with the DU.

10. The method of claim 9, further comprising transmitting an indication of the output power associated with the DU to the parent network node and receiving a command comprising the timing window based on the transmitted indication of the output power.

11. The method of claim 9, further comprising receiving a broadcast comprising a plurality of timing windows associated with a plurality of output power values.

12. The method of claim 5, further comprising receiving a command comprising a reference window for a reference output power and deriving the timing window from the reference window, the reference output power and an actual output power associated with the DU.

13. The method of claim 1, wherein the adjustment of the first transmission timing comprises an adjustment of an MT transmission timing to align with a DU transmission timing is based at least in part on two different types of MT transmission timings, a first type of MT transmission timing following a timing control command from the parent network node and a second type of MT transmission timing aligning to the DU transmission timing at the network node.

14. The method of claim 13, wherein the first type of MT transmission timing following the timing control command is not aligned to the DU transmission timing at the network node.

15. The method of claim 13, wherein the first type of MT transmission timing is based at least in part on a relation between the first and second types of MT transmission timings.

16. The method of claim 15, wherein the relation is one of derived by and signaled to the parent network node.

17. The method of claim 13, wherein the adjustment of the MT transmission timing to align with the DU transmission timing is based at least in part on a timing window, the timing window indicates an amount of deviation allowed for the second type of MT transmission timing relative to the first type of MT transmission timing.

18. The method of claim 17, further comprising receiving a command comprising the timing window from one of the parent network node, a centralized unit, CU, and an operations, administration, and maintenance, OAM, function.

19. (canceled)

20. The method of claim 17, wherein the timing window is one of symmetric and asymmetric about the first type of MT transmission timing.

21.-23. (canceled)

24. The method of claim 1, further comprising determining a timing offset between the MT and DU transmission timings based at least in part on a timing misalignment of at least one other network node.

25. A method implemented in a network node configured to communicate with a child network node over a backhaul network, the method comprising:
transmitting a signaling related to a timing alignment; and
receiving a Mobile Terminated Unit, MT, transmission based at least in part on an adjustment of a first transmission timing to align with a second transmission timing, the first transmission timing comprising one of a Distributed Unit, DU, and an MT transmission timing at the child network node and the second transmission timing comprising another one of the DU and the MT transmission timing at the child network node.

26.-47. (canceled)

48. A network node configured to communicate with a parent network node over a backhaul network, the network node comprising a Mobile Terminated Unit, MT, a Distributed Unit, DU, and processing circuitry, the processing circuitry comprising a memory and a processor, the memory comprising instructions and the processor configured to:
adjust a first transmission timing to align with a second transmission timing, the first transmission timing comprising one of a DU and an MT transmission timing at the network node and the second transmission timing comprising another one of the DU and the MT transmission timing at the network node; and
cause transmission of a signaling according to the adjustment of the first transmission timing.

49. A network node configured to communicate with a child network node over a backhaul network, the network node comprising processing circuitry, the processing circuitry comprising a memory and a processor, the memory comprising instructions and the processor configured to execute the instructions to:
cause transmission of a signaling related to a timing alignment; and
receive a Mobile Terminated Unit, MT, transmission based at least in part on an adjustment of a first transmission timing to align with a second transmission timing, the first transmission timing comprising one of a Distributed Unit, DU, and an MT transmission timing at the child network node and the second transmission timing comprising another one of the DU and the MT transmission timing at the child network node.
